(19) United States
(12) Patent Application Publication
(10) Pub. No.: US 2009/0028989 A1
(43) Pub. Date: Jan. 29, 2009

(54) Process for the Production of Phospholipids

(75) Inventors: Michael Schneider, Tromso (NO); Erik Lovaas, Tromso (NO)

Correspondence Address: Ballard Spahr Andrews & Ingersoll, LLP, SUITE 1000, 999 PEACHTREE STREET, ATLANTA, GA, 30309-3915, US

(73) Assignee: PROBIO GROUP AS, Tromso (NO)

(21) Appl. No.: 11/887,750

(22) PCT Filed: Apr. 4, 2006
(86) PCT No.: PCT/GB2006/001241

§ 371 Date: Jun. 9, 2008

(30) Foreign Application Priority Data
Apr. 4, 2005 (GB) 0506788.9

(51) Int. Cl. C11B 1/10; A23K 1/10; A23K 1/18; A23D 9/013; A23L 1/30

(52) U.S. Cl. 426/2; 426/608; 426/429

(57) ABSTRACT

The present invention provides a phospholipid composition obtainable by a process comprising contacting a fish meal with an organic solvent to produce a lipid-containing liquid, and subjecting said liquid to microfiltration optionally followed by solvent stripping.

This invention relates to a process for the production of a phospholipid composition, in particular a composition comprising marine phospholipids, and to phospholipid compositions produced thereby.

Phospholipids from marine sources are manufactured today from dried or moist biomasses using a number of different extraction processes.

Because of the naturally low phospholipid contents (between 1% and 5% wt in wet marine raw materials) the end products are expensive due to high raw material and extraction costs. Consequently, the final products are applied mainly in high price market segments such as, for example, in nutraceuticals and pharmaceuticals as well as for highly sophisticated aquaculture larvae feed compositions.

The substances presently marketed are generally obtained from roe, krill or from squid skin. The annual quantity does not exceed 10 metric tons—mainly due to the high costs.

Marine phospholipids contain an extremely high percentage of omega-3 fatty acids and are also rich in phosphatidylcholine. This leads to exceptional nutritional characteristics which make it highly desirable to offer such substances to a wider market, e.g. for human foods and also the general feed and aquaculture industry.

Long chain omega-3 fatty acids bound to phospholipids play an essential role for growth, survival rate and the development of a proper functioning immune system in fish larvae.

Feeding animals, which are intended for human consumption, with certain amounts of omega-3 phospholipids leads to a positive contribution of balancing the omega-6 to omega-3 fatty acid ratio in human nutrition towards the ideal 2:1 ratio—a shift which is highly desirable according to nutritional science theories.

The legal requirement for feed and feed ingredients with regard to contamination with environmental poisons like PCB's and dioxins is very strict. This has led to problems in the fish meal producing industry, because of seriously high contamination levels especially in fish from the North and Baltic Seas.

We have now surprisingly found that solvent extraction using organic solvents followed by separation of phospholipids, e.g. by microfiltration or by solvent precipitation can be used to produce a phospholipid composition which has sufficiently low levels of contaminants to be useable without further purification.

Thus viewed from one aspect the invention provides a process for the production of a phospholipid composition from a fish meal, which process comprises contacting the fish meal with an organic solvent to produce a lipid containing liquid, contacting said liquid, optionally after solvent stripping, with a second solvent in which neutral lipids are more soluble than polar lipids whereby to precipitate a phospholipid composition, optionally contacting the soluble neutral lipids (e.g. the residual liquid), optionally after solvent stripping, with an adsorbent material whereby to remove contaminants therefrom. The invention also provides phospholipid compositions obtainable by the above process.

Viewed from a further aspect the invention provides a process for the production of a phospholipid composition from a fish meal, which process comprises contacting the fish meal with an organic solvent to produce a lipid containing liquid, and subjecting said liquid to microfiltration (e.g. to a membrane separation process) using polymeric or ceramic membranes, optionally followed by solvent stripping. The invention also provides phospholipid compositions obtainable by the above process.

In the process of the invention, the fish meal used may be any marine fish meal, e.g. conventionally produced fish meal. The fish meal can also be prepared from fish, from roe, krill or squid, in particular squid skin or fish waste.

The organic solvent used in the process to produce a lipid-containing liquid may be any solvent in which phospholipids and triglycerides (i.e. fish oil) are soluble. Typically an alkane such as hexane iso-hexane, cyclohexane or heptane may be used. Generally the solvent will be used in a weight ratio between 1:1 and 10:1, especially between 2:1 and 5:1, preferably 3:1 relative to the fish meal.

Following the extraction step (which forms the lipid-containing liquid), the lipid solution is then preferably separated from the residual solids, e.g. by filtration. The residual solids, preferably following solvent removal, e.g. under reduced pressure, may then be used in ways conventional for fish meal, e.g. as a feed component, especially for fish feed.

Desirably the lipid solution is subjected to solvent removal, e.g. under reduced pressure, with the solvent typically being recycled for use in the solvent extraction step.

The lipid product is predominantly fish oil containing a relatively high proportion of phospholipids and contaminants such as PCBs and dioxins.

For the precipitation step, any solvent which exhibits a difference in solubility between polar lipids (e.g. phospholipids) and neutral lipids (e.g. oil, triglycerides, free fatty acids, cholesterol, some pigments and lipophilic contaminants such as dioxins, PCB's, PAH's etc) can be used e.g. supercritical CO₂, propane, CO₂/propane mixtures, ethanol/water mixtures (particularly up to 25% water) or ketones (especially acetone). Acetone is particularly preferred.

The solvent used for the precipitation step is typically used in a weight ratio between 1:1 and 15:1, especially between 3:1 and 10:1, preferably 7:1 relative to the lipid product so treated.

The precipitated phospholipids are preferably removed from the triglyceride-containing fraction, e.g. by filtration or any other type of separation. The separated phospholipid is preferably dried and may then be used directly, or after dissolution in any type of oil or fat, e.g. as a feed component, for example in a feedstuff containing further nutrients, e.g. proteins, oils, carbohydrates, vitamins, minerals, etc. If desired the phospholipids may be chemically modified, e.g. by enzymatic head group exchange, before further use. The separated and optionally chemically modified phospholipid and compositions containing them form further aspects of the invention. Surprisingly and unexpectedly the PCB content in the phospholipid may be ten to fifteen times lower than that in the triglyceride (fish oil) containing fraction. Such low contamination levels mean that the phospholipids may be used without further purification.

Alternatively, following contact with the organic solvent, the phospholipid fraction may be separated from the triglyceride fraction using membrane or microfiltration separation. Thus, in another embodiment of the invention to remove/reduce the dioxin contamination level in lipid extracts from contaminated fish meals the alkane (hexane, iso-hexane, cyclohexane, heptane, etc) extract of the fish meal containing neutral lipids (mainly triglycerides, free fatty acids, cholesterol, some pigments and the lipophilic contaminants like dioxins, PCB's, PAH's etc.) and polar lipids (mainly phospholipids) is subjected to a membrane or microfiltration separation process to separate phospholipids from neutral lipids prior to distillation of the solvent.

The basic principle of such a microfiltration step to reduce the level of contaminants in a phospholipid concentrate is described in the following.

In non-polar alkane solvents phospholipids aggregate into large molecular weight micellar structures, whereas all neutral lipids are dissolved in molecular disperse solution.

The phospholipid micelles of molecular weights up to 200,000 (approx. diameter=1 μm) are too big to diffuse across microfiltration membranes having pore sizes of approx. 0.1 to 0.5 μm). All neutral lipids, including the lipophilic contaminants, however, are able to pass through the pores of the membrane.

Suitable commercially available microfiltration membranes are made from polymeric materials, such as for example, polyacrylonitrile (PAN), polysulfone (PS), polyamide (PA) or polyimide (PI) or from ceramic materials.

Subjecting the alkane solution containing the lipophilic extract from fish meal to this microfiltration process at a moderate transmembrane pressure of 1 to 5 bars results in a substantially phospholipid free permeate containing the major portion of lipophilic contaminants and a retentate with a phospholipid concentrate, contaminant depleted.

Dependent on the ratio of membrane surface area to total volume of solution, phospholipid concentration of the fish meal extract, circulation time, pressure etc. the phospholipid concentration in the retentate can be exactly determined.

Because of the relatively small molecular weight of the lipophilic contaminants, they are transferred across the membrane in the same ratio to other neutral lipids as in the starting mixture. That means if the process is run to triple the phospholipid content, the level of lipophilic contaminants is reduced by a factor of three, etc.

After separation both the permeate (neutral lipids) and the retentate (containing a phospholipid concentrate together with a predetermined amount of remaining neutral lipids) are transferred into a suitable distillation unit to remove and to recover the solvent.

As most feed formulators require ingredients which are easy to handle and to dose it is desirable to increase the phospholipid content to a level which still allows the phospholipid concentrate to flow.

The triglyceride fraction is preferably subjected to solvent removal, e.g. under reduced pressure and once again the removed solvent may be recycled and reused. The resulting fish oil composition may then be subjected to conventional treatment with an adsorbent (e.g. activated carbon) to reduce the levels of contamination by PCBs and dioxin to yield a product which itself may be used in feed.

The phospholipid compositions of the invention may typically be used for feeding animals, as components of larvae feed for aquaculture, as components of fish feed, as components for feed for terrestrial animals, as components for pet food, as components for formulations to improve survival rates, immune response and the general health conditions of animals, as components of feed in order to modify the omega-6 to omega-3 ratio of animal products for human consumption or for human application after enzymatic or chemical modification.

The invention will now be described further with reference to the following non-limiting Examples.

### EXAMPLE 1

### Acetone Precipitation

1,000 kg of conventionally prepared, dioxin contaminated fish meal was extracted with hexane in a batch extractor to yield (after careful separation, filtration and hexane removal) 52 kg of an oil containing 21% of phospholipids. The extracted crude oil contained a dioxin level of 4.01 ppt TEQ (gas chromatography).

400 l of acetone were put in an extraction vessel at ambient temperature and the dioxin contaminated crude oil was slowly poured into the acetone under continuous and vigorous stirring. The phospholipids immediately formed a flocculate precipitate.

The oil-containing supernatant was removed, fresh acetone (250 l) was again added under stirring and the phospholipid precipitate was washed to remove residual neutral lipids.

After removal of the acetone the phospholipid residue was carefully dried under vacuum at 40° C.

An analysis of the phospholipid fraction showed a reduced dioxin level of only 0.31 ppt TEQ.

The dioxin contamination was determined by gas chromatography after several steps of enrichment.

### EXAMPLE 2

### Membrane Filtration

Fish meal is extracted with hexane to result in a hexane solution of neutral and polar lipids having a total lipid content of 26% with 6.970 ppm phosphorus (equal to 19.2% phospholipids) and 4.13 ppt dioxin in the lipid part.

A PAN membrane filter unit in the form of spiral wound element having an average pore size of 0.3 μm is preconditioned first with propanol for approximately 12 hours, then with a mixture of propanol/hexane 1:1 for 12 hours and finally with the extraction solvent hexane for another 12 hours.

Processing of the sample solution at 2 bars transmembrane pressure to a phosphorus content in the retentate of 16.030 ppm phosphorus in the lipid portion (equal to 44.1% phospholipids) results in a permeate flow of 59 l/hour m². The remaining phosphorus content in the permeate can be expected to be around 117 ppm in the solvent free lipid portion.

The dioxin content of the retentate lipid can be expected to reduce to around to 2.07 ppt.

1. A phospholipid composition obtainable by a process comprising contacting a fish meal with an organic solvent to produce a lipid-containing liquid, and subjecting said liquid to microfiltration optionally followed by solvent stripping.

2. The phospholipid composition according to claim 1, wherein said microfiltration comprises a membrane separation process.

3. A phospholipid composition obtainable by a process comprising
a) contacting a fish meal with an organic solvent to produce a lipid-containing liquid,
b) contacting said liquid, optionally after solvent stripping, with a second solvent, in which neutral lipids are more soluble than polar lipids whereby to precipitate a phospholipid composition, and
c) optionally contacting the liquid, after contacting with the second solvent, and optionally after solvent stripping, with an adsorbent material whereby to remove a contaminant therefrom.

4. The composition according to claim 1, wherein said fish meal is prepared from squid skin or fish waste.

5. A process for the production of a phospholipid composition, wherein said process comprises contacting a fish meal with an organic solvent to produce a lipid-containing liquid, and subjecting said liquid to microfiltration optionally followed by solvent stripping.

6. A process comprising feeding an animal with the composition of claim 1.

7-13. (canceled)

14. A process comprising at least one of: preparing a food composition suitable for feeding an organism, feeding a food composition to an organism, or a combination thereof, wherein the food composition comprises the phospholipid composition of claim 1.

15. The process of claim 14, wherein the food composition is a larvae feed, and wherein the organism is an aquaculture.

16. The process of claim 14, wherein the organism is a fish.

17. The process of claim 14, wherein the organism is a terrestrial animal.

18. The process of claim 14, wherein the food composition is a pet food.

19. The process of claim 14, wherein the food composition is capable of improving at least one of a survival rate, an immune response, a general health condition, or a combination thereof of an animal.

20. The process of claim 14, wherein the food composition is capable of modifying a ratio of omega-6 to omega-3 of an animal product for human consumption.

21. The process of claim 14, wherein the food composition is suitable, after enzymatic or chemical modification, for human application.
